(19) United States
(12) Patent Application Publication
(10) Pub. No.: US 2026/0080253 A1
(43) Pub. Date: Mar. 19, 2026

(54) METHOD FOR COMPRESSING PROMPT INFORMATION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xinjiang Lu, Beijing (CN); Lijun Liu, Beijing (CN); Jingbo Zhou, Beijing (CN)

(73) Assignee: BEIJING BAIDU NETCOM SCIENCE TECHNOLOGY CO., LTD., Beijing (CN)

(21) Appl. No.: 19/403,516

(22) Filed: Nov. 28, 2025

(30) Foreign Application Priority Data
Jun. 20, 2025 (CN) 202510838740.0

(51) Int. Cl. G06N 3/09; G06F 40/12

(52) U.S. Cl. CPC G06N 3/09; G06F 40/12

(57) ABSTRACT

A method for compressing prompt information includes: obtaining first prompt information of a language model (LM); obtaining target length constraint information; and obtaining second prompt information of the LM by compressing the first prompt information based on the target length constraint information; in which a number of first tokens of the first prompt information is greater than a number of second tokens of the second prompt information, and semantics of the second prompt information is relevant to semantics of the first prompt information.

### CROSS-REFERENCE TO RELATED APPLICATION

This application is based upon and claims priority to Chinese Patent Application No. 2025108387400, filed on Jun. 20, 2025, the entire contents of which are incorporated herein by reference.

### TECHNICAL FIELD

The disclosure relates to a field of artificial intelligence technologies, particularly to technical fields such as natural language processing and deep learning, and more particularly to a method and an apparatus for compressing prompt information, an electronic device, and a storage medium.

### BACKGROUND

With a wide application of a large language model (LLM) in a natural language processing task, the LLM shows a powerful reasoning and comprehension capability in a long-text processing scenario. However, as an input context increases, the LLM faces a challenge of computational complexity increasement and performance degradation, particularly in key information extraction and reasoning processes. In addition, since a black-box application programming interface (API) charge based on a number of tokens, a lengthy prompt may cause significant cost increasement.

### SUMMARY

According to a first aspect of the disclosure, there is provided a method for compressing the prompt information, including: obtaining first prompt information of a language model (LM); obtaining target length constraint information; and obtaining second prompt information of the LM by compressing the first prompt information based on the target length constraint information; in which a number of first tokens of the first prompt information is greater than a number of second tokens of the second prompt information, and semantics of the second prompt information is relevant to semantics of the first prompt information.

According to a second aspect of the disclosure, an electronic device is provided. The electronic device includes at least one processor; and a memory communicatively coupled to the at least one processor, in which the memory stores instructions executable by the at least one processor, and the at least one processor is caused to perform the method for compressing the prompt information of the first aspect when the instructions are executed by the at least one processor.

According to a third aspect of the disclosure, there is provided a non-transitory computer-readable storage medium for storing a computer program/computer instructions, in which the computer instructions are configured to cause the computer to execute the method of the first aspect.

### BRIEF DESCRIPTION OF THE DRAWINGS

The accompanying drawings are used for a better understanding of the disclosure and do not constitute a limitation of the disclosure.

FIG. 1 is a flow chart illustrating a method for compressing prompt information according to an embodiment of the disclosure.

FIG. 2 is a flow chart illustrating a method for compressing prompt information according to another embodiment of the disclosure.

FIG. 3 is a flow chart illustrating a method for compressing prompt information according to another embodiment of the disclosure.

FIG. 4 is a flow chart illustrating a method for compressing prompt information according to another embodiment of the disclosure.

FIG. 5 is a flow chart illustrating a method for compressing prompt information according to another embodiment of the disclosure.

FIG. 6 is a schematic diagram illustrating performing supervised fine-tuning (SFT) on a pre-trained language model (LM) according to an embodiment of the disclosure.

FIG. 7 is a block diagram illustrating an apparatus for compressing prompt information according to an embodiment of the disclosure.

FIG. 8 is a block diagram illustrating an electronic device configured to implement a method for compressing prompt information according to an embodiment of the disclosure.

### DETAILED DESCRIPTION

Description is made below to exemplary embodiments of the disclosure in combination with accompanying drawings, which includes various details of the embodiments of the disclosure to facilitate understanding, and should be considered as examples merely. Therefore, it should be recognized by the skilled in the art that various changes and modifications may be made to the embodiments described herein without departing from the scope and spirit of the present disclosure. Meanwhile, for clarity and conciseness, descriptions for well-known functions and structures are omitted in the following description.

Description is made below to a method and an apparatus for compressing prompt information, an electronic device, and a storage medium in embodiments of the disclosure with reference to the accompanying drawings.

Artificial intelligence (AI) is a subject studying that a computer is enabled to simulate thinking processes and intelligent behaviors (such as learning, reasoning, thinking, planning and the like) of a human. The AI involves both hardware-level technologies and software-level technologies. The AI hardware technologies generally include several major aspects such as computer vision technology, speech recognition technology, natural language processing technology, machine learning/deep learning, big data processing technology, and knowledge graph technology.

Natural language processing (NLP) is an important direction in the fields of computer science and the AI. The NLP studies various theories and methods that enable effective communication between humans and computers using natural language. The NLP is a science that integrates linguistics, computer science, and mathematics. The NLP is mainly applied to aspects such as machine translation, public opinion monitoring, automatic summarization, opinion extraction, text classification, question answering, text semantic comparison, and speech recognition.

Deep learning (DL) is a new research direction in the field of machine learning (ML). The DL is introduced into the ML to bring the DL closer to its original goal-AI. The DL involves learning inherent patterns and representational hierarchies of sample data. The information obtained during the learning greatly aids in the interpretation of data such as text, images, and sound. An ultimate goal of the DL is to enable a machine to have an analytical learning capability like humans, allowing the machine to recognize data such as text, images, and sound. The DL is a complex ML algorithm that has achieved results in speech and image recognition and far surpasses previous related technologies.

To solve the problems, a prompt compression technology is proposed, which aims to expand an input scope of a large language model (LLM) by reducing a prompt length while maintaining or improving a performance of a downstream task. However, soft prompt and hard prompt compression methods in the related art suffer from problems such as insufficient interpretability, poor generalization capability, and semantic incoherence, which are difficult to achieve an efficient and high-quality prompt compression in a practical application.

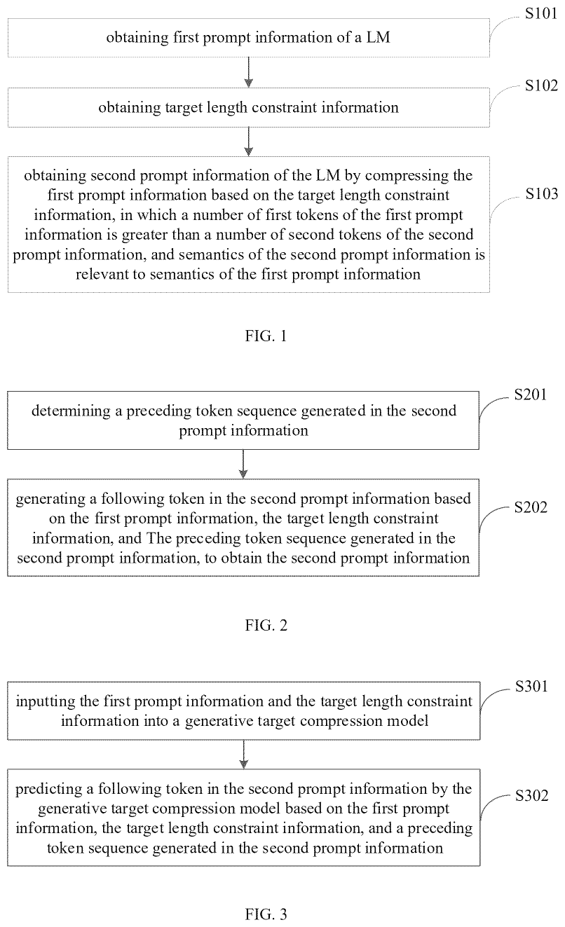

FIG. 1 is a flow chart illustrating a method for compressing prompt information according to an embodiment of the disclosure.

As shown in FIG. 1, the method for compressing the prompt information may include the following.

At block S101, first prompt information of a language model (LM) is obtained.

It should be noted that, the method for compressing the prompt information in embodiments of the disclosure may be applied to a scenario of text prompt information processing, and may also be applied to a scenario of sentence prompt information processing, which is not limited herein. An executive subject of the method for compressing the prompt information in embodiments of the disclosure may be an apparatus for compressing prompt information in embodiments of the disclosure. The apparatus for compressing the prompt information may be set in an electronic device. Alternatively, the executive subject may include a server, a user equipment, and other intelligent devices. Alternatively, the user equipment includes, but is not limited to, a mobile phone, a computer, an intelligent speech interactive device, and the like. Alternatively, the server includes, but is not limited to, a network server, or an application server; or may be a server in a distributed system, or a server combined with a block chain, and the like, which is not limited in embodiments of the disclosure.

The LM refers to a DL model with a very large number of parameters (typically ranging from hundreds of millions to trillions of parameters) and trained on massive amounts of data, which may understand and generate natural language and have certain capabilities such as reasoning, programming, logical judgment, and the like. The LM in the disclosure particularly refers to an AI model.

It should be noted that the prompt information refers to a paragraph of text instructions or questions input by a user when the AI model is used, and is used to guide the model to generate a specific type of answer, perform a task, or conduct reasoning.

The prompt information may be text prompt information, or may be speech prompt information input by a requester via a speech input device, which is not limited herein.

At block S102, target length constraint information is obtained.

It should be noted that the target length constraint information refers to constraints imposed on a length of an output result in certain optimization, search, or generation tasks. The constraints are generally used to control a scale of an output content, ensuring that the output content meets a requirement of a specific application scenario.

The target length constraint information may be pre-designed, or may be set manually based on an actual usage requirement, which is not limited herein.

In another possible implementation, the target length constraint information may also be changed based on a field or scenario to which an input prompt text belongs. For example, a target length constraint information corresponding to a prompt text when a question is asked may be different from the target length constraint information corresponding to a prompt text when data is generated.

In another possible implementation, the target length constraint information may also include a uniform format required after compression, such as, respective formats corresponding to an advertising copy, a summary, and a classification label constrained in the target length constraint information when the advertising copy, the summary, the classification label, etc. are generated automatically. Thus, the compressed prompt information has a unified format and clear structure, which is more suitable for constructing an automated prompt generation system.

At block S103, second prompt information of the LM is obtained by compressing the first prompt information based on the target length constraint information, in which a number of first tokens of the first prompt information is greater than a number of second tokens of the second prompt information, and semantics of the second prompt information is relevant to semantics of the first prompt information.

It should be noted that obtaining the second prompt information by compressing the first prompt information refers to generating a shorter, more concise prompt text on a premise of maintaining semantic integrity, thus improving the model response efficiency, reducing the token consumption, or adapting to a specific input limitation.

In a possible implementation, obtaining the second prompt information by compressing the first prompt information based on the target length constraint information may refer to involve generating the second prompt information that meets the target length constraint information by filtering out the first prompt information based on the target length constraint information.

In another possible implementation, sequential filtering may be performed based on an order of the first prompt information in the prompt text until the second prompt information meeting the target length constraint information is selected.

In another possible implementation, the compression process is not merely an operation of filtering and deleting the first prompt information. The compression process may also be converting a long token or phrase into a short token or phrase that express the same meaning, thus generating a shorter and more concise prompt text on a premise of ensuring the semantic integrity.

In embodiments of the disclosure, the first prompt information of the LM is obtained, the target length constraint information is obtained, and the second prompt information of the LM is obtained by compressing the first prompt information based on the target length constraint information, in which the number of first tokens of the first prompt information is greater than the number of second tokens of the second prompt information. By compressing the first prompt information based on the target length constraint information, a data amount for data analysis by an artificial intelligence model may be reduced, processing cost and data processing time may be reduced, and calling charges of the black-box application programming interface (API) may be reduced.

In embodiments of the disclosure, obtaining the second prompt information by compressing the first prompt information based on the target length constraint information may include: determining a token number difference between the number of first tokens and the number of second tokens; and in response to the token number difference being less than a first set value, re-compressing the first prompt information until a token number difference corresponding to the generated second prompt information is greater than or equal to the first set value.

It should be noted that re-compressing refers to rewriting and compressing the first prompt information, to reduce the number of tokens of the first prompt information, thus achieving simplification on the first prompt information. The re-compressing is not performed only once, but depends on a result of the re-compressing. For example, if a current re-compressed result does not meet a current requirement or an end condition, the re-compressing needs to be performed again based on the current compression result.

In a possible implementation, by the re-compressing operation, a phrase or sentence having the same semantics in the first prompt information may be replaced with a phrase or sentence with the small number of tokens.

In another possible implementation, by the re-compressing operation, a word that has a little impact on instructions or semantics may be deleted from the first prompt information.

In another possible implementation, in response to the token number difference being less than the first set value, a re-compression indication is generated and the re-compression indication is displayed. By determining whether the token number difference between the number of tokens before and after prompt information compression reaches a preset threshold, it is decided whether to perform re-compression, thus ensuring that each compression achieves a significant effect, improving the model usage efficiency, reducing costs, and enhancing the intelligence and stability of a prompt information generation system.

It should be noted that the re-compression indication is used to indicate whether the first prompt information currently compressed should be compressed again, to further reduce a size or adapt to a specific format requirement. For example, in the case that the first prompt information subjected to re-compression already meets a condition where the token number difference is less than the first set value, the re-compression indication may be “re-compression is not required”; or in the case that the current first prompt information subjected to the re-compression still does not meet the condition where the token number difference is less than the first set value, the re-compression indication may be “re-compression is still required”, and re-compression processing is performed on the first prompt information currently compressed until the condition where the token number difference is less than the first set value is met.

It should be noted that the first set value is determined based on the target length constraint information, and the first set value may also be included in the target length constraint information.

In the above embodiments, obtaining the second prompt information by compressing the first prompt information based on the target length constraint information may be further explained with reference to FIG. 2. The method includes the following.

At block S201, a preceding token sequence generated in the second prompt information is determined.

At block S202, a following token in the second prompt information is generated based on the first prompt information, the target length constraint information, and the preceding token sequence generated in the second prompt information, to obtain the second prompt information.

It should be noted that a token is the smallest semantic unit or the smallest grammatical unit used when a model processes the text. It should be noted that a token is not equivalent to a Chinese character, a letter, a word, or a punctuation mark, but determined based on a tokenizer strategy of the model. For example, “Hello world!” may be divided into three tokens: “Hello”, “world”, and “!”; “Transformer-based model” may be divided into four tokens: “Trans”, “former”, “-based”, “model”, and the like. It should be noted that different AI models may have different dividing results for the same prompt text. For example, Model A may divide “Transformer-based model” into four tokens: “Trans”, “former”, “-based”, “model”, and Model B might may divide “Transformer-based model” into five tokens: “Tran”, “sfor”, “mer-”, “base”, “dmod”, and “el”.

It may be understood that i-th token in the second prompt information is obtained by sequentially compressing based on the first prompt information. Thus, in the disclosure, the preceding token sequence generated in the second prompt information refers to the sequence of tokens generated before generating the i-th token, where, i is an integer, 2≤i≤M, and M is the number of second tokens.

In embodiments of the disclosure, there are various methods for generating the tokens based on prompt information input to an AI model, which are not limited herein.

Alternatively, a preset dividing rule may be employed to determine a word boundary of the prompt text to generate tokens. The dividing rule may be modified based on an actual design requirement, which is not limited herein. For example, a regular expression may be used to match a specific pattern to obtain tokens from the prompt information.

Alternatively, words of the prompt information may also be divided by a preset predefined dictionary or vocabulary to generate tokens.

Alternatively, the prompt information may also be processed by a preset dividing model to generate tokens. The preset dividing model may be a neural network model, such as, a bidirectional long short-term memory (BiLSTM) network model, a Transformer model, or the like.

In embodiments of the disclosure, after obtaining the preceding token sequence, there are various methods for generating the i-th token in the second prompt information based on the first prompt information, the target length constraint information, and the preceding token sequence.

In a possible implementation, the prompt text is text with semantics or a specific requirement, and the second prompt information generated after compressing the first prompt information still needs to maintain the same semantics or requirement as the first prompt information. Therefore, when the tokens of the first prompt information are sequentially compressed, there needs to adjust a subsequent token compression rule based on the semantics of the obtained preceding token sequence of the second prompt information, thus ensuring the semantic integrity of the second prompt information and ensuring the consistency between the second prompt information and the first prompt information. Simultaneously, there also needs to constrain the second prompt information finally generated based on the target length constraint information to meet a length requirement, a format requirement, etc., in the target length constraint information.

In embodiments of the disclosure, the preceding token sequence generated in the second prompt information is determined first, and the following token in the second prompt information is generated based on the first prompt information, the target length constraint information, and the preceding token sequence generated in the second prompt information, to obtain the second prompt information. Thus, by generating the following token in the second prompt information based on the first prompt information, the target length constraint information, and the preceding token sequence, high-quality prompt information conforming to the length constraint may be dynamically generated without losing task semantics, effectively improving the model usage efficiency, reducing the costs, and enhancing the controllability and practicality of prompt information generation.

In the above embodiments, obtaining the second prompt information of the LM by compressing the first prompt information based on the target length constraint information may be further explained with reference to FIG. 3.

At block S301, the first prompt information and the target length constraint information are input into a generative target compression model.

It should be noted that the generative target compression model in embodiments of the disclosure may be an autoregressive generative model. The autoregressive generative model is a type of DL model widely used in fields such as natural language processing, speech synthesis, and image generation.

In embodiments of the disclosure, a following token is progressively predicted based on the existing first prompt information, thus generating the complete second prompt information.

The generative target compression model in embodiments of the disclosure is pre-trained and may be stored in the storage space of an electronic device for convenient access when needed.

For example, for a first prompt information sequence x=(x₁, x₂, . . . , xₙ), where n represents the number of tokens of an original prompt, a compressed second prompt information sequence is \hat{x}=(\hat{x}₁, \hat{x}₂, . . . , \hat{x}ₘ), where m represents the number of tokens of a compressed prompt, and m<<n. A compression ratio t is defined as m/n, with a value range of (0, 1].

A mathematical expression of the generative target compression model is:

$${C}_{θ} ( x \vert x , {L}_{t} ) = {\prod }_{i = 1}^{m} {C}_{θ} ( {x}_{i} \vert x , {L}_{t} , {x}_{1} , … , {x}_{i - 1} ) ,$$

where, C_{θ} represents a lightweight compressor model with a parameter being θ, Lₜ represents the target length constraint, and the generation of \hat{x}ᵢ not only depends on the first prompt information x but also on a sequence of tokens previously generated.

From the above expression, it may be seen that the generative target compression model in the solution may ensure that the generated compressed prompt information maintains semantic coherence. Compared with conventional methods, the generative framework includes the following advantages: 1) allowing generating a new expression rather than simply deleting a token; 2) maintaining a natural language characteristic of a generated text; 3) supporting dynamic length control.

At block S302, a following token in the second prompt information is predicted by the generative target compression model based on the first prompt information, the target length constraint information, and a preceding token sequence generated in the second prompt information.

In embodiments of the disclosure, the first prompt information and the target length constraint information are input into the generative target compression model, and then the following token in the second prompt information is predicted by the generative target compression model based on the first prompt information, the target length constraint information, and the preceding token sequence generated in the second prompt information. Thus, by processing the first prompt information and the target length constraint information via the generative target compression model to generate the second prompt information, semantic coherence of the generated compressed prompt information may be ensured, and the compression efficiency of the first prompt information may be improved.

In the above embodiments, obtaining the target length constraint information may be further explained with reference to FIG. 4. The method includes the following.

At block S401, a target downstream task associated with the first prompt information is determined.

In an implementation, there may be a significantly large difference between requirements of different tasks for prompt information, and different tasks may correspond to different target length constraint information. Therefore, starting from the task, the target length constraint information may be deduced reversely, which may be adapted to different models or application scenarios.

There may be various kinds of target downstream tasks. For example, the target downstream task may include classification tasks, summary generation, programming assistance, and the like.

At block S402, the target length constraint information is determined based on the target downstream task.

In embodiments of the disclosure, the target length constraint information may be determined based on different target downstream tasks by pre-setting target length constraint information-a task mapping rule. For example, a range of the target length constraint information of the classification task could may be 50-100 tokens, the range of the target length constraint information of the summary generation may be 100-300 tokens, and the range of the target length constraint information of the programming assistance may be 100-400 tokens.

In a possible implementation, model computing capability information of a task model corresponding to the target downstream task may further be determined; task requirement information of the target downstream task is determined; and the target length constraint information is determined based on at least one of the task requirement information or the model computing capability information.

It should be noted that the task requirement information refers to the constraints of the task to be executed currently, for example, a minimum/ideal prompt information length required to complete the task, an output format requirement, a content complexity, etc.

The model computing capability information of the task model refers to the processing capability of the model, such as the maximum number of tokens supported, response latency, whether parallel computing is supported, etc.

The above embodiments describe a more refined and systematic method for generating the prompt information length constraint. The method considers not only the task requirement information of the downstream task but also combines the computational constraint of the model, such as an inference speed, maximum context support, etc., thus realizing a target length constraint information determining mechanism based on dual factors of “task-model”.

Alternatively, the target length constraint information may be determined based on merely the task requirement information. For example, in the case that the task requirement information indicates that the current task allows for a long response time, a large target length constraint information may be selected; in the case that the task requirement information indicates that the current task allows for a short response time, the target length constraint information may be appropriately increased.

Alternatively, the target length constraint information may be determined based solely on the model computing capability information of the task model. For example, in the case that there is a high available computing capability of the task model currently, a smaller target length constraint information may be selected; in the case that there is a low available computing power of the task model currently, the target length constraint information may be appropriately reduced.

Alternatively, the target length constraint information may be determined by comprehensively considering both the task requirement information and the model computing capability information. In embodiments of the disclosure, there are various methods for determining the target length constraint information by comprehensively considering the task requirement information and the model computing capability information. For example, weight values may be assigned to the task requirement information and the model computing capability information respectively, and then the target length constraint information may be determined by comprehensive calculation based on the task requirement information, the model computing capability information, and the respective weight values.

In embodiments of the disclosure, the target downstream task associated with the first prompt information is determined, and the target length constraint information is determined based on the target downstream task. Thus, by identifying the downstream task corresponding to the first prompt information and determining the target length constraint information accordingly, intelligent compression and optimization of the prompt information may be achieved, thus improving the model invocation efficiency, reducing costs, and enhancing the system adaptability and intelligence level.

In the above embodiments, obtaining the generative target compression model may be further explained with reference to FIG. 5. The method includes the following.

At block S501, a training sample is obtained, in which the training sample includes sample prompt information and reference prompt information corresponding to the sample prompt information.

It should be noted that the sample prompt information is prompt information that needs to be input to the AI model, and the reference prompt information corresponding to the sample prompt information is the reference prompt information output by the AI model performing compression based on the sample prompt information under ideal conditions.

At block S502, sample constraint length information of the training sample is determined.

In embodiments of the disclosure, determining the sample constraint length information of the training sample may refer to the content in the above embodiments, which is not repeated herein.

At block S503, the generative target compression model is obtained by performing supervised fine-tuning (SFT) on a pre-trained LM based on the training sample and the sample constraint length information.

The SFT refers to performing further fine-tuning on basis of the pre-trained LM by using an annotated high-quality data set. Thus, the model may be better adapted to a specific task or an application scenario, and the accuracy of the model may be improved.

In a possible implementation, the SFT involves further training the model on the basis of an existing large-scale pre-trained language model by using a labeled supervised data set, to enable the model better to adapt to a certain task (such as question answering, summarization, translation, code generation, etc.).

In embodiments of the disclosure, obtaining the generative target compression model by performing the SFT on the pre-trained LM based on the training sample and the sample constraint length information includes: inputting the training sample and the sample constraint length information into the LM, and outputting, by the LM, predicted prompt information corresponding to the sample prompt information based on the training sample and the sample constraint length information; determining a loss function of the LM by performing cross-entropy loss calculation on the predicted prompt information and the reference prompt information; and adjusting a model parameter of the LM based on the loss function until the SFT is completed, to obtain the generative target compression model.

In embodiments of the disclosure, a following token in the predicted prompt information is generated by the LM based on the sample prompt information, the sample constraint length information, and a preceding reference token sequence uploaded in the reference prompt information, to obtain the predicted prompt information.

Using a cross-entropy loss function for optimization may ensure a high degree of consistency between the compressed prompt generated by the model and the reference prompt in the token-level distribution.

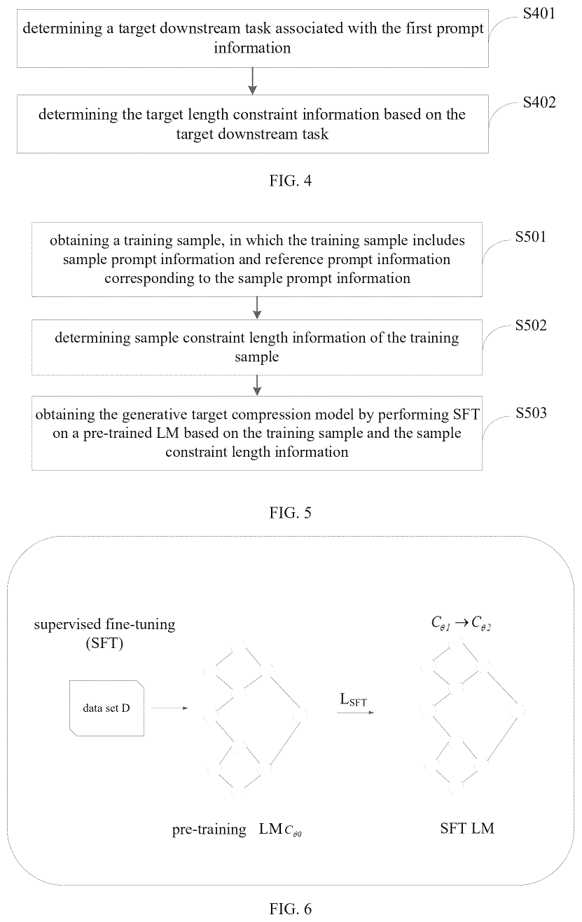

In embodiments of the disclosure, the process of performing the SFT on the pre-trained LM is illustrated in FIG. 6.

A data set D represents a data set used for supervised fine-tuning. The data set includes inputs and corresponding expected outputs.

Pre-trained LM C_{θ0}: representing inputting a sample (x) in the data set into a pre-trained LM, denoted as C_{θ0}. The model has undergone preliminary training by a large amount of text data and has certain language understanding and generation capabilities.

SFT process: the pre-trained model Coo is further optimized via supervised fine-tuning. In the process, the model parameter is updated from θ₀ to θ₁, and then updated to θ₂, i.e., C_{θ1}→C_{θ2}. This indicates that the model continuously learns knowledge specific to the task or application scenario in the data set D.

A loss function (L_{SFT}): the SFT employs one loss function L_{SFT}, which measures the difference between output generated by the model and expected output in the data set. By minimizing the loss function, the model may gradually adjust the parameter of the model, to better adapt to the specific task.

SFT LM: an LM optimized for a specific task after the SFT is obtained, called SFT LM. The performance of the model on the specific task is typically better than that of an original pre-trained model.

For example, given an original prompt x and a reference compressing prompt x_ref=(y₁, y₂, . . . , y_m), the loss function is defined by:

$${L}_{SFT} = - {E}_{( x , {x}_{ref} ) ∼ D} = [ {\sum }_{i = 1}^{m} {\sum }_{j = 1}^{\vert V \vert} I ( {y}_{i} = j ) \cdot log {C}_{θ} ( j / x , y < i ) ] ,$$

where, I(yᵢ=j) is an indicator function that takes the value 1 when the i-th token of the reference prompt is equal to the j-th word in the vocabulary V, and 0 otherwise; C_{θ}(j/x, y<i) represents the probability of the j-th token predicted in the case that the first i−1 tokens are given; and |V| represents the size of the vocabulary.

The cross-entropy loss function has the following technical advantages. (1) Precise token-level optimization: directly minimizing the difference between a model predicted distribution and a one-hot distribution of the reference prompt, ensuring that each generated token is as close as possible to a reference standard. (2) Stable gradient propagation: compared to a sequence-level index such as ROUGE-L, the cross-entropy loss provides a more direct and stable gradient signal. (3) High training efficiency: perfectly matching the autoregressive generation process and supporting parallelized computation.

Corresponding to the method for compressing the prompt information provided in the several above embodiments, an embodiment of the disclosure further provides an apparatus for compressing prompt information. Since the apparatus for compressing the prompt information provided in embodiments of the disclosure corresponds to the method for compressing the prompt information provided in the several above embodiments, the implementation manner of the method for compressing the prompt information is also applicable to the apparatus for compressing the prompt information provided in the embodiment of the disclosure, which is not described in detail in following embodiments.

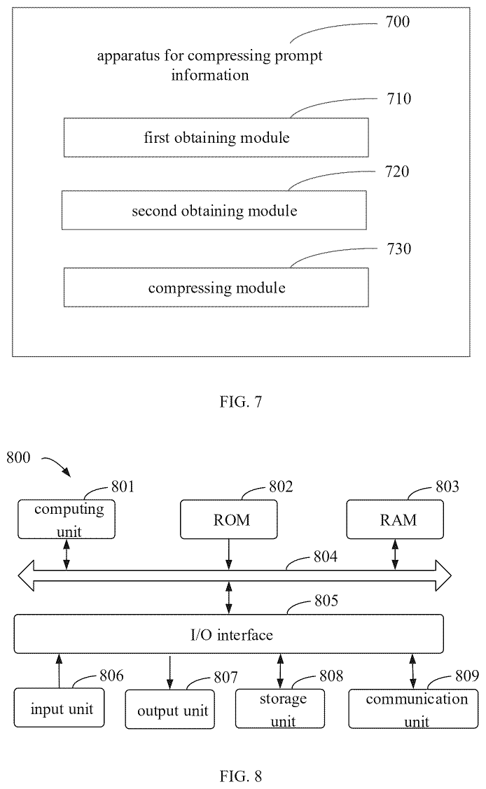

FIG. 7 is a block diagram illustrating an apparatus for compressing prompt information according to an embodiment of the disclosure. As illustrated in FIG. 7, the apparatus for compressing the prompt information includes a first obtaining module 710, a second obtaining module 720, and a compressing module 730.

The first obtaining module 710 is configured to obtain first prompt information of an LM.

The second obtaining module 720 is configured to obtain target length constraint information.

The compressing module 730 is configured to obtain second prompt information of the LM by compressing the first prompt information based on the target length constraint information, in which a number of first tokens of the first prompt information is greater than a number of second tokens of the second prompt information, and semantics of the second prompt information is relevant to semantics of the first prompt information.

In an embodiment of the disclosure, the compressing module 730 is also configured to generate a following token in the second prompt information based on the first prompt information, the target length constraint information, and a preceding token sequence generated in the second prompt information, to obtain the second prompt information.

In an embodiment of the disclosure, the compressing module 730 is also configured to input the first prompt information and the target length constraint information into a generative target compression model; and predict a following token in the second prompt information by the generative target compression model based on the first prompt information, the target length constraint information, and a preceding token sequence generated in the second prompt information.

In an embodiment of the disclosure, the second obtaining module 720 is also configured to determine a target downstream task associated with the first prompt information; and determine the target length constraint information based on the target downstream task.

In an embodiment of the disclosure, the second obtaining module 720 is also configured to determine model computing capability information of a task model corresponding to the target downstream task; determine task requirement information of the target downstream task; and determine the target length constraint information based on at least one of the task requirement information or the model computing capability information.

In an embodiment of the disclosure, the compressing module 730 is also configured to determine a token number difference between the number of first tokens and the number of second tokens; and in response to the token number difference being less than a first set value, re-compress the first prompt information until a token number difference corresponding to the second prompt information generated is greater than or equal to the first set value.

In an embodiment of the disclosure, the compressing module 730 is also configured to, in response to the token number difference being less than the first set value, generate a re-compression indication and display the re-compression indication.

In an embodiment of the disclosure, obtaining the generative target compression model includes: obtaining a training sample, in which the training sample includes sample prompt information and reference prompt information corresponding to the sample prompt information; determining sample constraint length information of the training sample; and obtaining the generative target compression model by performing SFT on a pre-trained LM based on the training sample and the sample constraint length information.

In an embodiment of the disclosure, obtaining the generative target compression model by performing the SFT on the pre-trained LM based on the training sample and the sample constraint length information includes: inputting the training sample and the sample constraint length information into the LM, and outputting, by the LM, predicted prompt information corresponding to the sample prompt information based on the training sample and the sample constraint length information; determining a loss function of the LM by performing cross-entropy loss calculation on the predicted prompt information and the reference prompt information; and adjusting a model parameter of the LM based on the loss function until the SFT is completed, to obtain the generative target compression model.

In an embodiment of the disclosure, the apparatus is also configured to generate a following token in the predicted prompt information by the LM based on the sample prompt information, the sample constraint length information, and a preceding reference token sequence uploaded in the reference prompt information, to obtain the predicted prompt information.

By compressing the first prompt information based on the target length constraint information to generate shorter second prompt information, the data amount for the artificial intelligence model performing data analysis may be reduced, processing cost and data processing time may be reduced, and calling charges of the black-box API may be reduced.

In the technical solution of the disclosure, processing including obtaining, storage, and application of the personal information of the user is in compliance with the provisions of relevant laws and regulations, and does not violate public order and moral.

According to embodiments of the disclosure, the disclosure also provides an electronic device, a readable storage medium, and a computer program product.

FIG. 8 is a block diagram illustrating an exemplary electronic device 800 for implementing embodiments of the disclosure. The electronic device is intended to represent various types of digital computers, such as a laptop computer, a desktop computer, a workstation, a personal digital assistant, a server, a blade server, a mainframe computer, and other suitable computers. The electronic device may also represent various types of mobile devices, such as a personal digital assistant, a cellular phone, a smart phone, a wearable device, and other similar computing devices. The components illustrated herein, connections and relations of the components, and functions of the component are merely examples, which are not intended to limit the implementations of the disclosure described and/or required herein.

As illustrated in FIG. 8, the device 800 includes a computing unit 801, configured to execute various appropriate actions and processes based on a computer program/instructions stored in a read-only memory (ROM) 802 or a computer program/instructions loaded from a storage unit 808 to a random access memory (RAM) 803. In the RAM 803, various programs and data required for the device 800 may be stored. The computing unit 801, the ROM 802 and the RAM 803 may be connected with each other by a bus 804. An input/output (I/O) interface 805 is also connected to the bus 804.

Multiple components in the device 800 are connected to the I/O interface 805, including: an input unit 806, such as, a keyboard, a mouse; an output unit 807, such as, various types of displays, speakers; a storage unit 808, such as, a magnetic disk, an optical disk; and a communication unit 809, such as, a network card, a modem, a wireless transceiver. The communication unit 809 allows the device 800 to exchange information/data through a computer network such as Internet and/or various types of telecommunication networks with other devices.

The computing unit 801 may be various types of general and/or dedicated processing components with processing and computing capabilities. Some examples of a computing unit 801 include, but not limited to, a central processing unit (CPU), a graphics processing unit (GPU), various dedicated artificial intelligence (AI) computing chips, various computing units on which a machine learning model algorithm runs, a digital signal processor (DSP), and any appropriate processor, a controller, microcontroller, etc. The computing unit 801 executes various methods and processes as described above, such as, the method for compressing the prompt information. For example, in some embodiments, the method for compressing the prompt information may be realized as a computer software program, which is tangibly contained in a machine readable medium, such as the storage unit 808. In some embodiments, a part or all of the computer program/instructions may be loaded and/or installed on the device 800 via the ROM 802 and/or the communication unit 809. When the computer program/instructions are loaded on the RAM 803 and executed by the computing unit 801, one or more steps in the method for compressing the prompt information may be performed as described above. Alternatively, in other embodiments, the computing unit 801 may be configured to execute the method for compressing the prompt information in other appropriate ways (such as, by virtue of a firmware).

Various implementations of the systems and techniques described above may be realized by a digital electronic circuit system, an integrated circuit system, field programmable gate arrays (FPGAs), application specific integrated circuits (ASICs), application specific standard products (ASSPs), system on chip (SOCs), load programmable logic devices (CPLDs), computer hardware, firmware, software, and/or a combination thereof. These various implementations may be implemented in one or more computer programs/instructions, the one or more computer programs may be executed and/or interpreted on a programmable system including at least one programmable processor, the programmable processor may be a dedicated or general programmable processor for receiving data and instructions from the storage system, at least one input device and at least one output device, and transmitting the data and instructions to the storage system, the at least one input device and the at least one output device.

The program codes for realizing the method of the disclosure may be written in any combination of one or more programming languages. These program codes may be provided for the processors or controllers of general-purpose computers, dedicated computers, or other programmable data processing devices, such that the program codes, when executed by the processor or controller, enable the functions/operations specified in the flow chart and/or block diagram to be implemented. The program codes may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media include electrical connections based on one or more wires, portable computer disks, hard disks, RAMS, ROMs, electrically programmable read-only-memory (EPROM or flash storage), fiber optics, compact disc read-only memories (CD-ROM), optical storage devices, magnetic storage devices, or any suitable combination of the above.

In order to provide interaction with a user, the systems and techniques described herein may be implemented on a computer having a display device (e.g., a cathode ray tube (CRT) or a liquid crystal display (LCD) monitor) for displaying information to a user; and a keyboard and pointing device (such as a mouse or trackball) through which the user may provide input to the computer. Other kinds of devices may also be used to provide interaction with the user. For example, the feedback provided to the user may be any form of sensor feedback (e.g., visual feedback, auditory feedback, or haptic feedback), and the input from the user may be received in any form (including acoustic input, speech input, or tactile input).

The systems and technologies described herein may be realized in a computing system that includes background components (such as, a data server), or a computing system that includes middleware components (such as, an application server), or a computing system that includes front-end components (such as, a user computer with a graphical user interface or a web browser, through which the user can interact with the implementation of the systems and technologies described herein), or include such background components, intermediate computing components, or any combination of front-end components. The components of the system may be interconnected by data communication (e.g., a communication network) of any form or medium digital. Examples of communication networks include: a local area network (LAN), a wide area network (WAN), the Internet, and the block-chain network.

The computer system may include a client and a server. The client and server are generally remote from each other and interact through a communication network. A client-server relationship is generated by computer programs/instructions running on the respective computers and having the client-server relationship with each other. The server may be a cloud server, also called a server in a distributed system, or a server integrated with a block-chain.

It should be understood that various forms of processes illustrated above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made based on a design requirement and other factors. Any modification, equivalent replacement and improvement made within the spirit and principle of the disclosure shall be included in the protection scope of the disclosure.

What is claimed is:

1. A method for compressing prompt information, comprising:
obtaining first prompt information of a language model (LM);
obtaining target length constraint information; and
obtaining second prompt information of the LM by compressing the first prompt information based on the target length constraint information;
wherein a number of first tokens of the first prompt information is greater than a number of second tokens of the second prompt information, and semantics of the second prompt information is relevant to semantics of the first prompt information.

2. The method of claim 1, wherein obtaining the second prompt information by compressing the first prompt information based on the target length constraint information comprises:
generating a following token in the second prompt information based on the first prompt information, the target length constraint information, and a preceding token sequence generated in the second prompt information, to obtain the second prompt information.

3. The method of claim 1, wherein obtaining the second prompt information of the LM by compressing the first prompt information based on the target length constraint information comprises:
inputting the first prompt information and the target length constraint information into a generative target compression model; and
predicting a following token in the second prompt information by the generative target compression model based on the first prompt information, the target length constraint information, and a preceding token sequence generated in the second prompt information.

4. The method of claim 1, wherein obtaining the target length constraint information comprises:
determining a target downstream task associated with the first prompt information; and
determining the target length constraint information based on the target downstream task.

5. The method of claim 4, wherein determining the target length constraint information based on the target downstream task comprises:
determining model computing capability information of a task model corresponding to the target downstream task;
determining task requirement information of the target downstream task; and
determining the target length constraint information based on at least one of the task requirement information or the model computing capability information.

6. The method of claim 1, further comprising:
determining a token number difference between the number of first tokens and the number of second tokens; and
in the case that the token number difference is less than a first set value, re-compressing the first prompt information until a token number difference corresponding to the second prompt information generated is greater than or equal to the first set value.

7. The method of claim 6, further comprising:
in the case that the token number difference is less than the first set value, generating a re-compression indication and displaying the re-compression indication.

8. The method of claim 3, wherein obtaining the generative target compression model comprises:
obtaining a training sample, wherein the training sample comprises sample prompt information and reference prompt information corresponding to the sample prompt information;
determining sample constraint length information of the training sample; and
obtaining the generative target compression model by performing supervised fine-tuning (SFT) on a pre-trained LM based on the training sample and the sample constraint length information.

9. The method of claim 8, wherein obtaining the generative target compression model by performing the SFT on the pre-trained LM based on the training sample and the sample constraint length information comprises:
inputting the training sample and the sample constraint length information into the LM, and outputting, by the LM, predicted prompt information corresponding to the sample prompt information based on the training sample and the sample constraint length information;
determining a loss function of the LM by performing cross-entropy loss calculation on the predicted prompt information and the reference prompt information; and
adjusting a model parameter of the LM based on the loss function until the SFT is completed, to obtain the generative target compression model.

10. The method of claim 9, further comprising:
generating a following token in the predicted prompt information by the LM based on the sample prompt information, the sample constraint length information, and a preceding reference token sequence uploaded in the reference prompt information, to obtain the predicted prompt information.

11. An electronic device, comprising:
at least one processor; and
a memory communicatively coupled to the at least one processor,
wherein the at least one processor is configured to:
obtain first prompt information of a language model (LM);
obtain target length constraint information; and
obtain second prompt information of the LM by compressing the first prompt information based on the target length constraint information;
wherein a number of first tokens of the first prompt information is greater than a number of second tokens of the second prompt information, and semantics of the second prompt information is relevant to semantics of the first prompt information.

12. The electronic device of claim 11, wherein the at least one processor is further configured to:
generate a following token in the second prompt information based on the first prompt information, the target length constraint information, and a preceding token sequence generated in the second prompt information, to obtain the second prompt information.

13. The electronic device of claim 11, wherein the at least one processor is further configured to:
input the first prompt information and the target length constraint information into a generative target compression model; and
predict a following token in the second prompt information by the generative target compression model based on the first prompt information, the target length constraint information, and a preceding token sequence generated in the second prompt information.

14. The electronic device of claim 11, wherein the at least one processor is further configured to:
determine a target downstream task associated with the first prompt information; and
determine the target length constraint information based on the target downstream task.

15. The electronic device of claim 14, wherein the processor is further configured to:
determine model computing capability information of a task model corresponding to the target downstream task;
determine task requirement information of the target downstream task; and
determine the target length constraint information based on at least one of the task requirement information or the model computing capability information.

16. The electronic device of claim 11, wherein the at least one processor is further configured to:
determine a token number difference between the number of first tokens and the number of second tokens;
in the case that the token number difference is less than a first set value, re-compress the first prompt information until a token number difference corresponding to the second prompt information generated is greater than or equal to the first set value; and
in the case that the token number difference is less than the first set value, generate a re-compression indication and displaying the re-compression indication.

17. The electronic device of claim 13, wherein the at least one processor is further configured to:
obtain a training sample, wherein the training sample comprises sample prompt information and reference prompt information corresponding to the sample prompt information;
determine sample constraint length information of the training sample; and
obtain the generative target compression model by performing supervised fine-tuning (SFT) on a pre-trained LM based on the training sample and the sample constraint length information.

18. The electronic device of claim 17, wherein the at least one processor is further configured to:
input the training sample and the sample constraint length information into the LM, and output, by the LM, predicted prompt information corresponding to the sample prompt information based on the training sample and the sample constraint length information;
determine a loss function of the LM by performing cross-entropy loss calculation on the predicted prompt information and the reference prompt information; and
adjust a model parameter of the LM based on the loss function until the SFT is completed, to obtain the generative target compression model.

19. The electronic device of claim 18, wherein the at least one processor is configured to:
generate a following token in the predicted prompt information by the LM based on the sample prompt information, the sample constraint length information, and a preceding reference token sequence uploaded in the reference prompt information, to obtain the predicted prompt information.

20. A non-transitory computer-readable storage medium for storing computer instructions, wherein the computer instructions are configured to cause a computer to execute a method for compressing prompt information,
wherein the method comprises:
obtaining first prompt information of a language model (LM);
obtaining target length constraint information; and
obtaining second prompt information of the LM by compressing the first prompt information based on the target length constraint information;
wherein a number of first tokens of the first prompt information is greater than a number of second tokens of the second prompt information, and semantics of the second prompt information is relevant to semantics of the first prompt information.
